(19) United States
(12) Patent Application Publication
(10) Pub. No.: US 2008/0201864 A1
(43) Pub. Date: Aug. 28, 2008

(54) Copolymers, Production and Use Thereof

(75) Inventors: Gerhard Wolf, Ketsch (DE); Matthias Kluglein, Ludwigshafen (DE); Stephan Huffer, Ludwigshafen (DE); Susanne Petrovic, Eppelheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, Ludwigshafen (DE)

(21) Appl. No.: 11/572,657

(22) PCT Filed: Jul. 30, 2005
(86) PCT No.: PCT/EP05/08278

§ 371 Date: Jan. 25, 2007

(30) Foreign Application Priority Data
Aug. 5, 2004 (DE) 10 2004 038 217.4

(51) Int. Cl. C14C 9/02; C08L 33/06; C14C 3/22

(52) U.S. Cl. 8/94.22; 524/560; 428/540

(57) ABSTRACT

The present invention relates to copolymers prepared by copolymerization in at least two stages, wherein, in one stage
(A) at least one (co)polymer is prepared from a monomer or a mixture of comonomers comprising
   (a1) from 80 to 100% by weight of at least one ethylenically unsaturated carboxylic acid,
   (a2) from 0 to 20% by weight of at least one C₁-C₂₂-alkyl ester of at least one ethylenically unsaturated carboxylic acid,
   (a3) from 0 to 10% by weight of at least one further ethylenically unsaturated compound,
      data in % by weight being based on the total amount of comonomers of the relevant stage,
      and the (co)polymer thus obtained is reacted in a subsequent stage
(B) with a further comonomer or a further mixture of comonomers comprising
   (b1) from 0 to 30% by weight of at least one ethylenically unsaturated carboxylic acid,
   (b2) from 70 to 100% by weight of at least one C₁-C₂₂-alkyl ester of at least one ethylenically unsaturated carboxylic acid,
   (b3) from 0 to 10% by weight of at least one further ethylenically unsaturated compound,
      data in % by weight being based on the total amount of comonomers of the relevant further stage.

The present invention relates to copolymers prepared by copolymerization in at least two stages, wherein, in one stage
(A) at least one (co)polymer is prepared from a monomer or a mixture of comonomers comprising
   (a1) from 80 to 1000 by weight of at least one ethylenically unsaturated carboxylic acid,
   (a2) from 0 to 20% by weight of at least one C₁-C₂₂-alkyl ester of at least one ethylenically unsaturated carboxylic acid,
   (a3) from 0 to 10% by weight of at least one further ethylenically unsaturated compound,
   data in % by weight being based on the total amount of comonomers of the relevant stage,
   and the (co)polymer thus obtained is reacted in a subsequent stage
(B) with a further comonomer or a further mixture of comonomers comprising
   (b1) from 0 to 30% by weight of at east one ethylenically unsaturated carboxylic acid,
   (b2) from 70 to 100% by weight of at least one C₁-C₂₂-alkyl ester of at least one ethylenically unsaturated carboxylic acid,
   (b3) from 0 to 10% by weight of at least one further ethylenically unsaturated compound,
      data in % by weight being based on the total amount of comonomers of the relevant further stage.

The present invention furthermore relates to a process for the preparation of copolymers according to the invention and uses of the copolymers according to the invention.

There is a demand for soft but mechanically strong leathers, for example in the apparel sector, in the automotive sector and in the furniture leather area. The leathers obtainable in many cases are either obtained in comparatively hard form or become hard in the course of use.

EP 0 418 661 describes the use of copolymers which comprise, incorporated in the form of polymerized units,

from 50 to 90% by weight of C₈-C₄₀-alkyl (meth)acrylates and/or vinyl esters of C₈-C₄₀-carboxylic acids and
from 10 to 50% by weight of monoethylenically unsaturated C₃-C₁₂-carboxylic acids, monoethylenically unsaturated C₄-C₁₂-dicarboxylic acids and/or monoethylenically unsaturated C₄-C₁₂-dicarboxylic anhydrides and/or monoesters or monoamides of monoethylenically unsaturated C₄-C₁₂-dicarboxylic acids or amides of monoethylenically unsaturated C₃-C₁₂-carboxylic acids and which have molar masses of from 500 to 30 000 g/mol. It is furthermore disclosed that the copolymers described are suitable in at least partly neutralized form in aqueous solution or aqueous dispersion for imparting water repellency to leather. The leathers obtained are, however, unsatisfactory with regard to their grain tightness.

WO 95/20056 describes aqueous polymer dispersions in which the polymer is obtained in each case from 50 to 90% by weight of alkyl acrylate and 10 to 50% by weight of (meth)acrylic acid, and its use for fatliquoring and filling leathers. The polymer dispersions prepared according to WO 95/20056 likewise have deficiencies in the grain tightness of the leathers. In addition, the combinability with other products used in tanning or retanning is only limited and may lead to negative results with regard to softness, fullness, dyeing and in particular grain tightness.

It was the object to provide leather treatment compositions which give leathers improved with regard to softness, fullness, dyeability and grain tightness and which can readily be used in combination with leather treatment compositions known from the prior art. It was furthermore the object to provide a process for the preparation of leather treatment compositions. It was furthermore the object to provide uses for treated leathers.

Accordingly, the copolymers defined at the outset were found. The copolymers according to the invention are prepared by copolymerization in at least two stages, i.e. by a multistage process, for example a two-stage process or three-stage process or a four-stage process.

Copolymers according to the invention are obtained by preparing at least one (co)polymer in one stage
(A) from a monomer or a mixture of comonomers comprising
   (a1) from 80 to 100% by weight, preferably from 90 to 100% by weight, of at least one ethylenically unsaturated carboxylic acid,
   (a2) from 0 to 20% by weight, preferably up to 10% by weight, of at least one C₁-C₂₂-alkyl ester of at least one ethylenically unsaturated carboxylic acid,
   (a3) from 0 to 10% by weight, preferably from 0.1 to 5% by weight, of at least one further ethylenically unsaturated compound,
   data in % by weight being based on the total amount of comonomers of the relevant stage,
   and reacting the (co)polymer thus obtained in a subsequent stage
(B) with a further comonomer or a further mixture of comonomers comprising
   (b1) from 0 to 30% by weight, preferably up to 20% by weight, of at least one ethylenically unsaturated carboxylic acid,
   (b2) from 70 to 100% by weight, preferably from 80 to 100% by weight, of at least one C₁₀₋₂₂-alkyl ester of at least one ethylenically unsaturated carboxylic acid,
   (b3) from 0 to 10% by weight, preferably from 0.1 to 5% by weight, of at least one further ethylenically unsaturated compound,
      data in % by weight being based on the total amount of comonomers of the relevant further stage.

Polymers according to the invention and a process for the preparation of polymers according to the invention, which is likewise a subject of the present invention, are described in more detail below.

Particularly suitable ethylenically unsaturated carboxylic acids (a1) are carboxylic acids of the general formula I

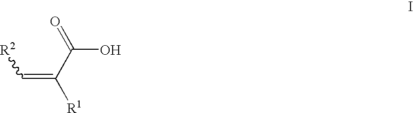

In formula I, the radicals are defined as follows:
R¹ is selected from hydrogen,
   CH₂—COOH, CH₂—COOCH₃, CH₂—COOC₂H₅ and
   C₁₋₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl, and very particularly preferably methyl;
R² is selected from
   C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl, particularly preferably C₁-C₄-alkyl, such as methyl, ethyl, n-propyl, isopropyl, n-butyl, isobutyl, sec-butyl and tert-butyl,
   COOH, COOCH₃, COOC₂H₅,
   and very particularly preferably hydrogen.

Very particularly preferably, R² is hydrogen and R¹ is hydrogen or methyl.

Acrylic acid, methacrylic acid or mixtures of acrylic acid and methacrylic acid are very particularly preferably used as the ethylenically unsaturated carboxylic acid (a1).

C₁-C₂₂-Alkyl esters of at least one ethylenically unsaturated carboxylic acid (a2) which are preferably chosen are those of the formula II

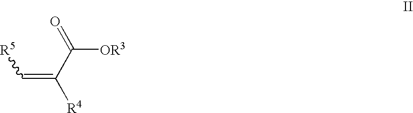

where the variables are defined as follows:
R³ is selected from C₁-C₂₂-alkyl, such as methyl, ethyl, n-propyl, isopropyl, n-butyl, isobutyl, sec-butyl, tert-butyl, n-pentyl, isopentyl, sec-pentyl, neopentyl, 1,2-di-methylpropyl, isoamyl, n-hexyl, isohexyl, sec-hexyl, n-heptyl, n-octyl, 2-ethyl-hexyl, n-nonyl, n-decyl, n-dodecyl, n-tetradecyl, n-hexadecyl, n-octadecyl and n-eicosyl, particularly preferably n-butyl and 2-ethylhexyl;
R⁴ is selected from hydrogen,
   CH₂—COOH, CH₂—COOCH₃, CH₂—COOC₂H₅ and
   C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl, particularly preferably C₁-C₄-alkyl, such as methyl, ethyl, n-propyl, isopropyl, n-butyl, isobutyl, sec-butyl and tert-butyl and very particularly preferably methyl;
R⁵ is selected from
   C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl,
   COOCH₃, COOC₂H₅
   and very particularly preferably hydrogen.

Very particularly preferably, R⁵ is hydrogen and R⁴ is hydrogen or methyl

Very particularly preferably, R⁵ is hydrogen and R⁴ is hydrogen or methyl and R³ is selected from methyl, ethyl, n-butyl and 2-ethylhexyl.

For example, suitable further ethylenically unsaturated compounds (a3) are:

vinyl esters of formic acid or of C₁-C₆-alkylcarboxylic acids, in particular vinyl acetate, (meth)acrylonitrile, (meth)acrylamide,
vinylphosphonic acid, N-vinylformamide, itaconic acid,
compounds substituted by at least one SO₃H group and having at least one C—C double bond, preferably vinylsulfonic acid or 2-acrylamido-2-methylpropanesulfonic acid

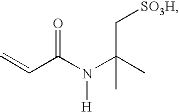

or their corresponding alkali metal or ammonium salts, 2-(N,N-dimethylamino)ethyl (meth)acrylate methochloride.

After the end of the (co)polymerization, the (co)polymer formed can be isolated and purified. It is also possible mechanically to process, for example to comminute, (co)polymer formed.

In an embodiment of the present invention, the purification of the (co)polymer formed is dispensed with and said (co)polymer is reacted in a further stage
(B) with a further comonomer or a further mixture of comonomers comprising
   (b1) from 0 to 30% by weight, preferably up to 20% by weight, of at least one ethylenically unsaturated carboxylic acid,
   (b2) from 70 to 100% by weight, preferably from 80 to 100% by weight, of at least one C₁-C₂₂-alkyl ester of at least one ethylenically unsaturated carboxylic acid,
   (b3) from 0 to 10% by weight, preferably from 0.5 to 5% by weight, of at least one further ethylenically unsaturated compound,
      data in % by weight being based on the total amount of comonomers of the relevant further stage.

Ethylenically unsaturated carboxylic acids (b1) are preferably selected from those of the general formula I. It is possible for the ethylenically unsaturated carboxylic acid (a1) and ethylenically unsaturated carboxylic acid (b1) to be identical or different. Thus, for example, methacrylic acid can be chosen as ethylenically unsaturated carboxylic acid (a1) and acrylic acid as ethylenically unsaturated carboxylic acid (b1). It is also possible to choose acrylic acid as the ethylenically unsaturated carboxylic acid (a1) and methacrylic acid as the ethylenically unsaturated carboxylic acid (b1).

In another variant of the present invention, ethylenically unsaturated carboxylic acid (a1) and ethylenically unsaturated carboxylic acid (b1) are in each case identical and are selected from (meth)acrylic acid.

C₁-C₂₂-Alkyl esters of ethylenically unsaturated carboxylic acid (b2) are preferably selected from those of the general formula II. It is possible for C₁-C₂₂-alkyl esters of ethylenically unsaturated carboxylic acid (a2) and C₁-C₂₂-alkyl esters of ethylenically unsaturated carboxylic acid (b2) to be identical or different. Thus, for example, methyl (meth)acrylate can be chosen as the C₁-C₂₂-alkyl ester of ethylenically unsaturated carboxylic acid (a2), and 2-ethylhexyl (meth)acrylate or n-butyl (meth)acrylate as the C₁-C₂₂-alkyl ester of ethylenically unsaturated carboxylic acid (b2). It is also possible to choose 2-ethylhexyl (meth)acrylate or n-butyl (meth)acrylate as the C₁-C₂₂-alkyl ester of ethylenically unsaturated carboxylic acid (a2) and methyl (meth)acrylate as the C₁-C₂₂-alkyl ester of ethylenically unsaturated carboxylic acid (b2).

In another variant of the present invention, C₁-C₂₂-alkyl esters of ethylenically unsaturated carboxylic acid (a2) and C₁-C₂₂-alkyl esters of ethylenically unsaturated carboxylic acid (b2) are identical in each case and, for example, are selected from methyl (meth)acrylate, 2-ethylhexyl (meth)acrylate and n-butyl (meth)acrylate.

Of course, mixtures of two or more different C₁-C₂₂-alkyl esters of ethylenically unsaturated carboxylic acid (b2) may be used in stage (B), for example a mixture of 50% by weight of ethyl acrylate and 50% by weight of n-butyl acrylate.

For example, suitable further ethylenically unsaturated compounds (b3) are:

vinyl esters of formic acid or of C₁-C₆-alkylcarboxylic acids, in particular vinyl acetate, (meth)acrylonitrile, (meth)acrylamide,
vinylphosphonic acid, N-vinylformamide, itaconic acid,
compounds substituted by at least one SO₃H group and having at least one C—C double bond, preferably vinylsulfonic acid or 2-acrylamido-2-methyl-propanesulfonic acid

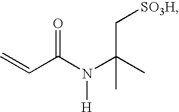

or their corresponding alkali metal or ammonium salts, 2-(N,N-dimethylamino)ethyl (meth)acrylate methochloride.

(b3) can be chosen to be different from or, preferably, identical to (a3)

In an embodiment of the present invention, in at least one further stage (C), it is possible to effect reaction with at least one further monomer selected from

(c1) at least one C₁-C₂₂-alkyl ester of at least one ethylenically unsaturated carboxylic acid.

C₁-C₂₂-Alkyl esters of ethylenically unsaturated carboxylic acid (c1) are preferably selected from those of the general formula II. It is possible for C₁-C₂₂-alkyl esters of ethylenically unsaturated carboxylic acid (c1) and C₁-C₂₂-alkyl esters of ethylenically unsaturated carboxylic acid (a2) or (b2) to be identical or different. Thus, for example, methyl (meth)acrylate can be chosen as the C₁-C₂₂-alkyl ester of ethylenically unsaturated carboxylic acid (c1) and 2-ethylhexyl (meth)acrylate or n-butyl (meth)acrylate as the C₁-C₂₂-alkyl ester of ethylenically unsaturated carboxylic acid (a2) or (b2), respectively. It is also possible to choose 2-ethylhexyl (meth)acrylate or n-butyl (meth)acrylate as the C₁-C₂₂-alkyl ester of ethylenically unsaturated carboxylic acid (c1) and methyl (meth)acrylate as the C₁-C₂₂-alkyl ester of ethylenically unsaturated carboxylic acid (a2) or (b2).

In another variant of the present invention, C₁-C₂₂-alkyl esters of ethylenically unsaturated carboxylic acid (c1) and C₁-C₂₂-alkyl esters of ethylenically unsaturated carboxylic acids (a2) and (b2) are in each case identical and are selected, for example, from methyl (meth)acrylate, 2-ethylhexyl (meth)acrylate and n-butyl (meth)acrylate.

In an embodiment of the present invention, the ratio of the mass of monomer or comonomers from stage (A) to the mass of monomer or comonomers from stage (B) is from 1:100 to 1:1, preferably from 1:20 to 1:2.

If, in the preparation of the copolymer according to the invention, it is desired to carry out one or more stages (C), the ratio of the masses of the sum of monomers or comonomers from (A) and (B) to the mass of (C) may be from 50:1 to 1:1, preferably from 20:1 to 2:1.

In an embodiment of the present invention, the difference between the glass transition temperatures T_{g} of polymer or random copolymer from stage (A) and polymer or random copolymer from stage (B) is at least 80° C., preferably at least 100° C. The glass transition temperatures T_{g} can be calculated, for example, according to the Fox equation or determined by DSC (differential scanning calorimetry) according, for example, to DIN 53765.

Polymer or random copolymer from stage (A) is to be understood as meaning polymer which can be isolated by carrying out stage (A). Polymer or random copolymer from stage (B) is to be understood as meaning those polymers or copolymers which are obtainable by polymerization or copolymerization of the (co)monomers (b2), if appropriate (b1) and if appropriate (b3) in the absence of polymer from stage (A).

In an embodiment of the present invention, polymer from stage (A) has a molecular weight M_{w} in the range from 30 000 g/mol to 750 000 g/mol, preferably in the range from 50 000 g/mol to 550 000 g/mol.

In an embodiment of the present invention, polymer or random copolymer from stage (B) has a molecular weight M_{w} in the range from 1000 g/mol to 200 000 g/mol, preferably in the range from 2000 g/mol to 100 000 g/mol.

The polydispersity M_{w}/Mₙ of copolymers according to the invention may be in the range from 1.1 to 40, preferably from 2 to 20.

The present invention furthermore relates to a process for the preparation of copolymers according to the invention, also referred to below as preparation process according to the invention.

The present invention furthermore relates to a process for the preparation of copolymers, wherein, in one stage
(A) at least one (co)polymer is prepared from a monomer or a mixture of comonomers comprising
   (b1) from 80 to 100% by weight of at least one ethylenically unsaturated carboxylic acid,
   (a2) from 0 to 20% by weight of at least one C₁-C₂₂-alkyl ester of at least one ethylenically unsaturated carboxylic acid,
   (a3) from 0 to 10% by weight of at least one further ethylenically unsaturated compound,
      data in % by weight being based on the total amount of comonomers of the relevant stage,
      and the (co)polymer thus obtained is reacted in a subsequent stage
(B) with a further comonomer or a further mixture of comonomers comprising
   (b1) from 0 to 30% by weight of at least one ethylenically unsaturated carboxylic acid,
   (b2) from 70 to 100% by weight of at least one C₁-C₂₂-alkyl ester of at least one ethylenically unsaturated carboxylic acid,
   (b3) from 0 to 10% by weight of at least one further ethylenically unsaturated compound,
      data in % by weight being based on the total amount of comonomers of the relevant further stage.

(Co)polymer from stage (A) can be prepared by any desired methods known from polymer chemistry, for example by solution polymerization, precipitation polymerization, mass polymerization, suspension polymerization and in particular emulsion polymerization.

Usually, (co)polymer from stage (A) is prepared using at least one initiator. At least one initiator may be a peroxide. Examples of suitable peroxides are alkali metal peroxodisulfates, e.g. sodium peroxodisulfate or ammonium peroxodisulfate, hydrogen peroxide, organic peroxides, such as diacetyl peroxide, di-tert-butyl peroxide, diamyl peroxide, dioctanoyl peroxide, didecanoyl peroxide, dilauroyl peroxide, dibenzoyl peroxide, bis(o-toloyl) peroxide, succinyl peroxide, tert-butyl peracetate, tert-butyl permaleate, tert-butyl perisobutyrate, tertbutyl perpivalate, tert-butyl peroctanoate, tert-butyl perneodecanoate, tert-butyl perbenzoate, tert-butyl peroxide, tert-butyl hydroperoxide, cumyl hydroperoxide, tert-butyl peroxy-2-ethylhexanoate and diisopropyl peroxydicarbamate. To compounds, such as, for example, azobisisobutyronitrile, azobis(2-amidopropane) dihydrochloride and 2,2′-azobis(2-methylbutyronitrile), are also suitable.

Redox initiators are likewise suitable for example comprising peroxides and an oxidizable sulfur compound. Systems comprising acetone bisulfite and organic peroxide, such as tert-C₄H₉—OOH, Na₂S₂O₅ (sodium disulfite) and organic peroxide such as tert-C₄H₉—OOH, or combinations of alkali metal salts of HO—CH₂SO₂H and organic peroxide, such as tert-C₄H₉—OOH, are very particularly preferred. Systems such as, for example, ascorbic acid/H₂O₂ are also particularly preferred.

In general, initiator is used in amounts of from 0.1 to 20% by weight, preferably from 0.2 to 15% by weight, based on the mass of all comonomers.

For example, temperatures in the range from 20 to 100° C., preferably from 50 to 90° C., can be chosen as the (co)polymerization temperature. The chosen temperature is dependent on the decomposition characteristics of the initiator used.

The pressure conditions are generally not critical; for example, pressures in the range from atmospheric pressure to 10 bar are suitable.

It is possible to use at least one emulsifier, which may be anionic, cationic or nonionic.

Suitable nonionic emulsifiers are, for example, ethoxylated mono-, di- and trialkylphenols (degree of ethoxylation: from 3 to 50, alkyl radical: C₄-C₁₂) and ethoxylated fatty alcohols (degree of ethoxylation: from 3 to 80, alkyl radical: C₈-C₃₆). Examples are the Lutensol® grades from BASF Aktiengesellschaft and the Triton® grades from Union Carbide.

Suitable anionic emulsifiers are, for example, alkali metal and ammonium salts of alkylsulfates (alkyl radical: C₈ to C₁₂), of sulfuric monoesters of ethoxylated alkanols (degree of ethoxylation: from 4 to 30, alkyl radical: C₁₂-C₁₈) and of ethoxylated alkylphenols (degree of ethoxylation: from 3 to 50, alkyl radical: C₄-C₁₂), of alkanesulfonic acids (alkyl radical: C₁₂-C₁₈), of alkylarylsulfonic acids (alkyl radical: C₉-C₁₈), of sulfosuccinates, such as, for example, sulfosuccinic mono- and diesters, and of carboxylates, such as, for example, N-oleylsarcosine.

Suitable cationic emulsifiers are as a rule primary, secondary, tertiary or quaternary ammonium salts having a C₆-C₁₈-alkyl, C₆-C₁₈-aralkyl or heterocyclic radical, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts Dodecylammonium acetate or the corresponding hydrochloride, the chlorides or acetates of the various 2-(N,N,N-trimethylammonium)ethylparaffinic acid esters, N-cetylpyridinium chloride, N-laurylpyridinium sulfate and N-cetyl-N,N,N-trimethylammonium bromide, N-dodecyl-N,N,N-trimethylammonium bromide, N,N-distearyl-N,N-dimethylammonium chloride and the Gemini surfactant N,N′-(lauryldimethyl)ethylenediamine dibromide may be mentioned by way of example. Numerous further examples are to be found in H. Stache, Tensid-Taschenbuch, Carl-Hanser-Verlag, Munich, Vienna, 1981, and in McCutcheon's, Emulsifiers & Detergents, MC Publishing Company, Glen Rock, 1989.

In an embodiment of the present invention, the amount of the emulsifier is chosen so that the mass ratio between monomer or comonomers on the one hand and emulsifier on the other hand is greater than 1, preferably greater than 10 and particularly preferably greater than 20.

According to the invention, the procedure is preferably carried out in the absence of oxygen, for example in a nitrogen or argon atmosphere, preferably in a nitrogen stream.

Conventional apparatuses, for example autoclaves and kettles, may be used for the preparation process according to the invention.

For the preparation of (co)polymer in stage (A), it is possible to use one or more regulators, for example C₁- to C₄-aldehydes, formic acid and organic compounds containing SH groups, such as 2-mercaptoethanol, 2-mercaptopropanol, mercaptoacetic acid, tert-butyl mercaptan and n-dodecyl mercaptan. Polymerization regulators are used in general in amounts of from 0.1 to 10% by weight, based on the total mass of the (co)monomers used. The procedure is preferably carried out without using regulators.

The duration of the (co)polymerization in stage (A) is in general from 30 minutes to 10 hours, preferably from 1 to 5 hours, particularly preferably from 3 to 5 hours.

After addition of (a1), if appropriate (a2) and if appropriate (a3), it is possible to allow the reaction to continue until (a1), if appropriate (a2) and if appropriate (a3) have been incorporated by polymerization completely or altogether in an amount of at least 50% by weight, i.e. until the end of the copolymerization in stage (A). However, it is also possible to adopt a procedure in which stage (B) is begun immediately after the addition of monomer or comonomers from stage (A) and incipient (co)polymerization.

Stage (B) can follow directly after the end of the (co)polymerization. After the end of the (co)polymerization, the (co)polymer prepared can first be isolated and, if appropriate, purified and then stage (B) can follow. It is also possible partly or quantitatively to neutralize the carboxyl groups of (co)polymer prepared according to stage (A) by addition of, for example, basic alkali metal compound or at least one amine.

In stage (B), (co)polymer obtained according to stage (A) and, if appropriate, isolated and/or purified and/or partly or completely neutralized is reacted with a further monomer or a further mixture of comonomers. Below, the term “a further mixture of comonomers” is used even when only one ethylenically unsaturated carboxylic acid (a1) has been polymerized in stage (A). In the following invention, the term “a further monomer or a further mixture of comonomers” is used even when in each case the same comonomers are used in the stages (A) and (B) but in different ratios.

The reaction in stage (B) is preferably effected as a free radical (co)polymerization, for example in the form of a mass or solution polymerization and particularly preferably in the form of an emulsion polymerization. For this purpose, the isolation of (co)polymer from stage (A) is very particularly preferably dispensed with and the procedure is continued in the same dispersion or solution or emulsion.

One or more initiators may be added before, after and/or during the addition of (b2), if appropriate (b1) and if appropriate (b3), it being possible for the initiator or initiators to be identical to or different from the initiator or the initiators from stage (A).

One or more emulsifiers may be added before, after and/or during the addition of (b2), if appropriate (b1) and if appropriate (b3), it being possible for the emulsifier or emulsifiers to be identical to or different from the emulsifier or the emulsifiers from stage (A).

One or more regulators may be added before, after and/or during the addition of (b2), if appropriate (b1) and if appropriate (b3), it being possible for the regulator or regulators to be identical to or different from the regulator or the regulators from stage (A). It is preferable to employ regulators in stage (B).

For example, temperatures in the range from 20 to 100° C., preferably from 50 to 90° C., can be chosen as the (co)polymerization temperature in stage (B). The chosen temperature is dependent on the decomposition characteristics of the initiator used.

The pressure conditions in stage (B) are in general not critical; for example, pressures in the range from atmospheric pressure to 10 bar are suitable.

The duration of the (co)polymerization in stage (B) is in general from 30 minutes to 10 hours, preferably from 1 to 8 hours, particularly preferably from 90 minutes to 6 hours.

If it is desired to effect a stage (C) after stage (B), a copolymer according to the invention can first be isolated and purified after the end of stage (B) and then stage (C) can be carried out by reaction with (c1). However, in another variant, it is possible to continue without isolation of copolymer according to the invention and to carry out stage (C) by reaction with (c1).

One or more emulsifiers may be added before, after and/or during the addition of (c1), it being possible for the emulsifier or emulsifiers to be identical to or different from the emulsifier or the emulsifiers from stage (A) or (B).

One or more regulators may be added before, after and/or during the addition of (c1), it being possible for the regulator or regulators to be identical to or different from the regulator or the regulators from stage (A) or (B), Stage (C) is preferably carried out with regulators.

For example, temperatures in the range from 20 to 100° C., preferably from 50 to 90° C., may be chosen as the (co)polymerization temperature in stage (C). The chosen temperature is dependent on the decomposition characteristics of the initiator used.

The pressure conditions in stage (C) are in general not critical; for example pressures in the range from atmospheric pressure to 10 bar are suitable.

The duration of the (co)polymerization in stage (C) is in general from 30 minutes to 10 hours, preferably from 1 to 5 hours.

It is possible for polymer or copolymer from step (B) to be grafted onto polymer or copolymer from stage (A). It is also possible for polymer or copolymer from stage (B) to surround or physically penetrate the polymer or polymers or the copolymer or copolymers from step (A) but without any covalent linkage taking place.

If the addition of monomer or comonomer from stage (B) has been started before monomer or comonomers from stage (A) are completely reacted, a blend of copolymers having different comonomer incorporation ratios is obtained. The blend thus obtainable may then comprise, for example, copolymers which are composed of comonomers from stage (A), which are composed of copolymers of stages (A) and (B) and which are composed of comonomers of stage (B).

If the preparation, according to the invention, of copolymer according to the invention has been carried out as a solution polymerization, copolymer according to the invention can be isolated, for example, by evaporating the solvent.

If the preparation, according to the invention, of copolymer according to the invention has been carried out as an emulsion polymerization, said copolymer is obtained in the form of aqueous dispersions or emulsions, to which the present invention likewise relates and from which said copolymer can, be isolated, for example, by filtering off or by evaporating the water, it being possible to carry out the evaporation, for example, by spray drying in one or more spray towers. In many cases, however, the isolation of copolymer according to the invention can be dispensed with and it can be used in the form of aqueous dispersions or emulsions according to the invention.

In an embodiment of the present invention, copolymer according to the invention is partly or completely neutralized, for example with a basic alkali metal compound or with an amine. Examples of basic alkali metal compounds are alkali metal hydroxide, such as, for example, NaOH and KOH, alkali metal carbonate, such as, for example, Na₂CO₃ and K₂CO₃, alkali metal bicarbonate, such as, for example, NaHCO₃ and KHCO₃. In the context of the present invention, examples of amines are ammonia and organic amines, such as trimethylamine, triethylamine, diethylamine, ethanolamine, N,N-diethanolamine, N,N,N-triethanolamine and N-methylethanolamine. If it is desired to effect neutralization with a basic alkali metal compound or with ammonia, it is advantageous to use the basic alkali metal compound or ammonia as an aqueous solution.

Aqueous dispersions or emulsions according to the invention may have a solids content in the range from 1% by weight to 70% by weight, preferably from 20% by weight to 60% by weight.

The present invention furthermore relates to the use of copolymers according to the invention, for example in the form of aqueous dispersions according to the invention, for the production of leather. The present invention furthermore relates to a process for the production of leather using copolymers according to the invention, for example in the form of aqueous dispersions according to the invention.

Below, leather is understood as meaning animal hides pretanned, preferably tanned, with the aid of alternatively chrome tanning agents, mineral tanning agents, polymer tanning agents, aldehyde tanning agents, such as, for example, glutaraldehyde, synthetic tanning agents, vegetable tanning agents, resin tanning agents or combinations of at least two of the abovementioned tanning agents.

In an embodiment of the present invention, leather comprises animal hide (wet blue) or semifinished products tanned with the aid of chrome tanning agents.

In a preferred embodiment of the present invention, leather comprises leather obtained from animal hide (wet white) or semifinished products tanned in the absence of chromium.

Copolymers according to the invention, for example in the form of dispersions according to the invention, can be used in tanning and preferably in retanning, referred to below as tanning process according to the invention or retanning process according to the invention. Dispersions according to the invention can be used in a separate treatment step.

The tanning process according to the invention is generally carried out so that a dispersion according to the invention or copolymer according to the invention is added in one portion or in a plurality of portions immediately before or during the tanning. The tanning process according to the invention is preferably carried out at a pH of from 2.5 to 8, preferably from 3 to 5.5.

In an embodiment of the present invention, the pH can be increased by about 0.3 to three units by adding basifying agents.

In another embodiment of the present invention, the tanning process according to the invention can be begun at a pH in the range from 4 to 8 and copolymer according to the invention can be fixed by adding an acidic component, such as, for example, formic acid, at a pH in the range from 3 to 5.5.

The tanning process according to the invention is generally carried out at temperatures of from 10 to 45° C., preferably at from 20 to 30° C. A duration of from 10 minutes to 12 hours has proven useful, and for one to three hours are preferred. The tanning process according to the invention can be carried out in any desired vessels customary in tanning, for example by drumming in barrels or in rotated drums.

In a variant of the tanning process according to the invention, dispersion according to the invention or copolymer according to the invention is used together with one or more conventional tanning agents, for example with chrome tanning agents, mineral tanning agents, preferably with syntans, polymer tanning agents or vegetable tanning agents, as described, for example, in Ullmann's Encyclopedia of Industrial Chemistry, Volume A15, pages 259 to 282 and in particular page 268 ff., 5th Edition, (1990), Verlag Chemie Weinheim.

In a variant of the tanning process according to the invention, dispersion according to the invention or copolymer according to the invention is used together with fatliquoring agents, such as natural triglycerides, white oil, paraffin, wax or silicone oil, and furthermore emulsifiers.

From 0.5 to 40% by weight, preferably from 2 to 20% by weight, based on the pelt weight, of dispersion according to the invention or copolymer according to the invention can be used in the tanning process according to the invention.

The process according to the invention for the treatment of leather can preferably be carried out as a process for retanning leather with the use of dispersion according to the invention or copolymer according to the invention. The retanning process according to the invention starts from semifinished products tanned conventionally, i.e. for example with chrome tanning agents, mineral tanning agents based on Al, Ti, Zr, Fe and Si, preferably with polymer tanning agents, aldehydes, vegetable tanning agents, syntans or resin tanning agents, or semifinished products produced according to the invention as described above. For carrying out the retanning according to the invention, copolymer according to the invention is allowed to act on semifinished products.

The retanning process according to the invention can be carried out under otherwise conventional conditions. Expediently, one or more, i.e. from 2 to 6, soaking steps are chosen, and washing with water can be effected between the soaking steps. The temperature during the individual soaking steps is in each case in the range from 5 to 60° C., preferably from 20 to 45° C.

In the retanning process according to the invention, from 0.5 to 40% by weight, preferably from 2 to 20% by weight, based on the shaved weight, of dispersion according to the invention or copolymer according to the invention can be used.

En the tanning process or retanning process according to the invention, compositions usually used during the retanning, for example fatliquors, polymer tanning agents, fatliquoring agents based on acrylate and/or on methacrylate or based on silicones, retanning agents based on resin and vegetable tanning agents, fillers, leather dyes or emulsifiers or combinations of at least 2 of the abovementioned substances, can of course be added to dispersion according to the invention or copolymer according to the invention.

As a result of the treatment according to the invention, leather is rendered water repellent or is fatliquored, i.e. improved fiber isolation results. Consequently, firstly the softness of the leather is improved and secondly the density of the leather is reduced, with the result that there are advantages with regard to comfort when leather produced according to the invention is used in pieces of furniture, automotive upholstery, apparel upper leather, such as, for example, upper leathers for shoes. As a result of the treatment, according to the invention, of the leather, in particular leather produced on the basis of wet white or on the basis of wet blue, the fullness and the hand properties of leather produced according to the invention are furthermore improved. Here, the term hand includes a soft, non-fatty, velvety surface hand which, combined with an inner softness of the leather, leads to an optimum overall impression of the leather. As a result of the treatment, according to the invention, of the leather, the grain tightness of leather produced according to the invention is also improved, i.e. a double-skin character of the leather, which is undesired by a person skilled in the art, is avoided, and the grain is dense and does not tend to split.

A further aspect of the present invention comprises leathers, for example leathers based on wet white or wet blue and particularly preferably leathers based on wet white, produced by the tanning process according to the invention or the retanning process according to the invention or by a combination of tanning process according to the invention and retanning process according to the invention. The leathers according to the invention are distinguished by an overall advantageous quality and, for example, have a particularly pleasant hand and are very soft and full. The leathers according to the invention comprise copolymer described above, penetrated particularly well into microregions of the elementary fibers.

A further aspect of the present invention is the use of leathers according to the invention, for example leathers according to the invention which are based on wet white or wet blue, for the production of articles of apparel, such as, for example, shoes, and furthermore pieces of furniture or automotive upholstery. A further aspect of the present invention is a process for the production of articles of apparel, such as, for example, shoes, and furthermore pieces of furniture or automotive parts, such as automotive upholstery, using leathers according to the invention, for example leathers according to the invention which are based on wet white or wet blue. In the context of the present invention, articles of apparel are, for example, jackets, pants, belts or suspenders and in particular shoes, in particular shoe soles, upper leather, shoe lining material and insoles. In the context of the present invention, pieces of furniture which comprise leather components, for example as seat surface or on arm rests, may be mentioned as pieces of furniture. Seating furniture may be mentioned by way of example, such as, for example, seats, chairs and sofas. Automotive upholstery, such as automobile seats and furthermore steering wheels and dashboards and door interior trims, may be mentioned by way of example as automotive parts.

A further aspect of the present invention relates to articles of apparel, comprising or produced from leather according to the invention. A further aspect of the present invention relates to furniture, comprising or produced from leathers according to the invention. A further aspect of the present invention relates to automotive parts, comprising or produced from leathers according to the invention.

A further aspect of the present invention relates to formulations comprising at least one copolymer according to the invention and at least one hydrophobic or amphiphilic substance selected from oils, waxes and synthetic polymers. A further aspect of the present invention relates to formulations comprising at least one copolymer according to the invention, at least one hydrophobic or amphiphilic substance selected from oils, waxes and synthetic polymers, and at least one emulsifier.

At least one hydrophobic substance selected from oils and waxes may be a carbon-based compound, for example natural or synthetic wax, natural or synthetic oil or natural or synthetic fat.

Beeswax, cork wax, montan waxes or carnauba wax may be mentioned as examples of natural waxes.

Polyethylene waxes or ethylene copolymer waxes, as obtainable, for example, by free radical polymerization of ethylene or free radical copolymerization of ethylene with, for example, (meth)acrylic acid or by Ziegler-Natta catalysis, may be mentioned as examples of synthetic waxes. Polyisobutylene waxes may furthermore be mentioned. Paraffin mixtures may furthermore be mentioned; these are to be understood as meaning mixtures of hydrocarbons which have 12 or more carbon atoms and usually have a melting point in the range from 25 to 45° C. Such paraffin mixtures may occur, for example, in refineries or crackers and are known to a person skilled in the art as slack wax and sasol waxes. Montan ester waxes are a further example of synthetic waxes.

Triglycerides which are liquid at room temperature, for example fish oil, neatsfoot oil, olive oil, cotton seed oil, castor oil, sunflower oil and peanut oil, may be mentioned as examples of natural oils.

White oil, liquid paraffin, functionalized paraffins, such as, for example, chlorinated or sulfochlorinated paraffins, or polyalkylene glycols, such as, for example, polyethylene glycol, may be mentioned as examples of synthetic oils.

Natural triglycerides which are solid at room temperature, such as, for example, lanolin, shellac wax and mixtures thereof, may be mentioned as examples of natural fats.

Maleic anhydride/α-olefin copolymers, as disclosed in EP-A 0 412 389, and furthermore copolymers obtainable by copolymerization of

at least one ethylenically unsaturated dicarboxylic anhydride derived from at least one dicarboxylic acid of 4 to 8 carbon atoms,
at least one oligomer of a branched or straight-chain C₃-C₁₀-alkene, at least one oligomer having an average molecular weight Mₙ in the range from 300 to 5000 g/mol or being obtainable by oligomerization of at least 3 equivalents of C₃-C₁₀-alkene, and hydrolysis of the anhydride groups, it optionally being possible to effect reaction with at least one preferably linear C₁-C₃₀-alkanol having a degree of ethoxylation of from one to 100 before the hydrolysis, may be mentioned as examples of synthetic polymers.

In a preferred embodiment of the present invention, a hydrophobic substance is at least one natural triglyceride.

In a preferred embodiment of the present invention, an amphiphilic substance is at least one synthetic polymer.

In a further preferred embodiment, a combination of at least one natural triglyceride which is solid or liquid at room temperature and a paraffin mixture having a melting point in the range from 25 to 40° C. is used. The ratio is not critical per se; for example, weight ratios of natural triglyceride to paraffin mixture in the range from 10:1 to 1:10 are suitable.

For example, from 10 to 70, preferably from 20 to 40, % by weight, based on formulation according to the invention, of one or more further hydrophobic compounds may be used.

In an embodiment of the present invention, formulations according to the invention comprise one or more emulsifiers which may be anionic, cationic, nonionic or zwitterionic.

Suitable nonionic emulsifiers are, for example, ethoxylated mono-, di- and trialkylphenols (degree of ethoxylation: from 3 to 50, alkyl radical: C₄-C₁₂) and ethoxylated fatty alcohols (degree of ethoxylation: from 3 to 80; alkyl radical: C₈-C₃₆). Examples are the Lutensol® grades from BASF Aktiengesellschaft.

Suitable anionic emulsifiers are, for example, alkali metal and ammonium salts of alkylsulfates (alkyl radical: C₈ to C₁₂), of sulfuric monoesters of ethoxylated alkanols (degree of ethoxylation: from 4 to 30, alkyl radical: C₁₂-C₁₈) and of ethoxylated alkylphenols degree of ethoxylation: from 3 to 50, alky radical: C₄-C₁₂), of alkanesulfonic acids (alkyl radical: C₁₂-C₁₈), of alkylarylsulfonic acids (alkyl radical: C₉-C₁₈) and of sulfosuccinates, such as, for example, sulfosuccinic mono- and diesters.

Suitable cationic emulsifiers are as a rule primary, secondary, tertiary or quaternary ammonium salts having a C₆-C₁₈-alkyl, C₆-C₁₈-aralkyl or heterocyclic radical, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts. Dodecylammonium acetate or the corresponding hydrochloride, the chlorides or acetates of the various 2-(N,N,N-trimethylammonium)ethylparaffinic acid esters, N-cetylpyridinium chloride, N-laurylpyridinium sulfate and N-cetyl-N,N,N-trimethylammonium bromide, N-dodecyl-N,N,N-trimethylammonium bromide, N,N-distearyl-N,N-dimethylammonium chloride and the Gemini surfactant N,N′-(lauryldimethyl)ethylenediamine dibromide may be mentioned by way of example. Numerous further examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

Particularly suitable emulsifiers are N-acylated amino acid derivatives, for example of the formula III

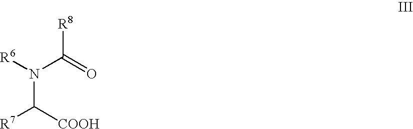

in which the variables are defined as follows:
R⁶ is C₁-C₄-alkyl, such as methyl, ethyl, n-propyl, isopropyl, n-butyl, isobutyl, sec-butyl and tert-butyl, in particular methyl,
R⁷ is hydrogen,
   C₁-C₄-alkyl, such as methyl, ethyl, n-propyl, isopropyl, n-butyl, isobutyl, sec-butyl and tert-butyl, in particular methyl,
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

The group CO—R⁸ is preferably derived from saturated or unsaturated fatty acids. Saturated fatty acids are to be understood as meaning carboxylic acids having C₉-C₂₀-alkyl groups, which may be linear or branched, substituted or unsubstituted. For example, R⁸ may be, n-nonyl, n-decyl, n-dodecyl, n-tetradecyl, n-pentadecyl, n-octadecyl or n-eicosyl.

CO—R⁸ may be derived from an unsaturated fatty acid having 9 to 20 carbon atoms and one to 5 C—C double bonds, it being possible for the C—C double bonds to be, for example, isolated or allylic, for example the acyl radical of linoleic acid, of linolenic acid and very particularly preferably of oleic acid.

In an embodiment of the present invention, all or at least a certain proportion, for example a third or a half, of the carboxyl groups in N-acylated amino acid derivatives of the formula IV which are used as emulsifiers have been neutralized. For example, basic salts, such as hydroxides or carbonates of the alkali metals such as, for example, Na or K, are suitable for the neutralization. Ammonia, alkylamines, such as, for example, methylamine, dimethylamine, trimethylamine, ethylamine, diethylamine, triethylamine or ethylenediamine, and very particularly alkanolamines, such as, for example, ethanolamine, diethanolamine, triethanolamine, N-methylethanolamine, N-methyldiethanolamine or N-(n-butyl)diethanolamine, are furthermore suitable for the neutralization.

N-Oleylsarcosine, N-stearylsarcosine, N-lauroylsarcosine and N-isononanoylsarcosine and the respective ethanolammonium salts, diethanolammonium salts and N-methyldiethanolammonium salts may be mentioned as examples of typical compounds of the formula III.

Other particularly suitable examples of emulsifiers are those of the general formula IV

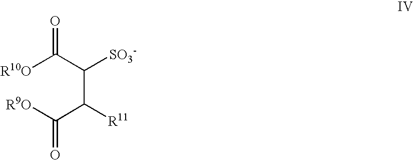

in which the variables are defined as follows:
R⁹ and R¹⁰ are identical or preferably different and are selected from hydrogen,
   C₁-C₃₀-alkyl, branched or straight-chain, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-undecyl, n-dodecyl, n-tridecyl, n-tetradecyl, n-hexadecyl, n-octadecyl or n-eicosyl, preferably radicals which are branched in the β-position and are of the formula IV a

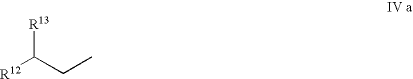

—(CH₂CH₂O)ₓ—O—R¹⁴ or —[CH(CH₃)CH₂O)—O—R¹⁴, where x is an integer in the range from 1 to 20,
C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl;
R¹¹ is selected from C₁-C₄-alkyl, such as methyl, ethyl, n-propyl, isopropyl, n-butyl, isobutyl, sec-butyl and tert-butyl,
   and in particular hydrogen;
R¹² and R¹³ are identical or preferably different and are selected from C₁-C₂₇-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-undecyl, n-dodecyl, n-tridecyl, n-tetradecyl, n-hexadecyl, n-octadecyl and n-eicosyl;
   the sum of the carbon atoms of R¹² and R¹³ being not more than 30. R¹¹ preferably has two carbon atoms more than R¹²; for example, the following combinations are preferred:
   R¹²=n-undecyl and R¹³=n-nonyl,
   R¹²=n-dodecyl and R¹³=n-decyl,
   R¹²=n-tridecyl and R¹³=n-undecyl,
   R¹²=n-tetradecyl and R¹³=n-dodecyl,
   R¹²=n-pentadecyl and R¹³=n-tridecyl.
R¹⁴ is selected from C₁-C₄-alkyl, such as methyl, ethyl, n-propyl, isopropyl, n-butyl, isobutyl, sec-butyl and tert-butyl,
   phenyl, ortho-tolyl, meta-tolyl, para-tolyl
   and in particular hydrogen.

In a preferred embodiment of the present invention, exactly one of the radicals R⁹ and R¹⁰ is hydrogen and the other radical is selected from C₁-C₃₀-alkyl.

In a particularly preferred embodiment of the present invention, a mixture of a plurality of emulsifiers, for example of the formula IV, which may differ, for example, in that, in the first compound of the formula IV, R⁹ is hydrogen and R¹⁰ is selected from C₁-C₃₀-alkyl and, in the second one, R¹⁰ is hydrogen and R⁹ is selected from C₁-C₃₀-alkyl, is chosen.

In an embodiment of the present invention, all or at least a certain proportion, for example a third or a half, of the sulfonyl groups in emulsifiers of the formula IV have been neutralized. For example, basic salts, such as hydroxides or carbonates, of the alkali metals, such as, for example, Na or K, are suitable for the neutralization. Ammonia, alkylamines, such as, for example, methylamine, dimethylamine, trimethylamine, ethylamine, diethylamine, triethylamine or ethylenediamine, and very particularly alkanolamines, such as, for example, ethanolamine, diethanolamine, triethanolamine, N-methylethanolamine, N-methyldiethanolamine or N-(n-butyl)diethanolamine, are furthermore suitable for the neutralization.

The preparation of compounds of the formula IV is known per se and is described in WO 01/68584. It is possible, for example, by mono- or diesterification of dicarboxylic anhydrides of the general formula V

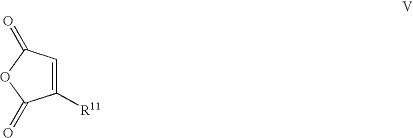

with corresponding alcohols, which need not be present in pure form, followed by a reaction with disulfite, for example with Na₂S₂O₅.

Formulations according to the invention may comprise mixtures of different emulsifiers instead of purified emulsifiers, for example of the formula IV. For example, it is possible to add the mixture known as oxo oil 135 or oxo thick oil 135 (WO01/68584) for the esterification and to use the mixture of esters thus obtainable as an emulsifier.

In an embodiment of the present invention, emulsifiers present in formulations according to the invention may comprise up to 40% by weight, preferably up to 20% by weight, based on emulsifier, of at least one alcohol of the formula VI

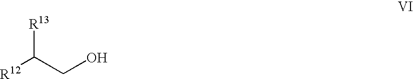

where, in formula VI, the variables R¹² and R¹³ are defined as above.

In a preferred embodiment of the present invention, emulsifiers present in dispersions according to the invention may comprise up to 40% by weight, particularly up to 20% by weight, of mixtures which comprise at least one alcohol of the general formula X; oxo oil 135 and oxo oil 13 may be mentioned by way of example for such mixtures.

In an embodiment, formulations according to the invention comprise a combination of two emulsifiers, of which one emulsifier is selected from emulsifiers of the general formulae III and IV and the other emulsifier is selected from ethoxylated fatty alcohols having a degree of ethoxylation of from 3 to 80 and an n-C₈-C₃₆-alkyl radical.

In an embodiment of the present invention, formulations according to the invention comprise
α) from 50 to 100% by weight, preferably from 60 to 90% by weight, of copolymer according to the invention,
β) from 0 to 50% by weight, preferably from 10 to 40% by weight, of hydrophobic substance selected from oils, waxes and synthetic polymers,
γ) from 0 to 20% by weight, preferably from 1 to 15% by weight, of emulsifier,
   data in % by weight being based in each case on the solids content of the total formulation according to the invention.

The remainder of the formulation according to the invention is preferably water.

Formulations according to the invention permit particularly simple metering of copolymers according to the invention. Formulations according to the invention are furthermore distinguished by good performance characteristics, such as, for example, shelf life.

Formulations according to the invention can be prepared by methods known per se, for example by mixing the individual components water, α), optionally β) and optionally γ). The sequence of the addition of the individual components water, α), optionally β) and optionally γ) is not critical, Mixing can be effected, for example, by simple stirring of the components, for example in a stirred kettle, for example using a mixer or an Ultra-Thurax stirrer. Preferably, a further homogenization is carried out, for example using a gap homogenizer or in a stirred kettle. Formulations according to the invention which are particularly stable during storage are obtained if at least one further homogenization is carried out.

The invention is explained by working examples.

### General Remarks:

Unless stated otherwise, all reactions were carried out under an atmosphere of nitrogen.

The characterization of copolymers according to the invention was carried out with the aid of a preparative ultracentrifuge and subsequent size exclusion chromatograph (SEC), serum and dispersed phase being separated. The serum was diluted in distilled water with 0.08 mol/l of tris(hydroxymethyl)aminomethane buffer at a pH of 7 with addition of 0.15 mol/l of Cl ions (as NaCl) and 0.001 mol/l of NaN₃. The calibration was effected using an Na-PAA mixture 23250/158/2 sodium salt of polyacrylic acid) which had a broad distribution and whose integral molecular weight distribution curve had been determined by combined SEC/laser light scattering, by the calibration method of M. J. R. Cantow et al. (J. Polym. Sci. A-1, 5 (1967) 1391-1394), but without the concentration correction proposed there.

The glass transition temperature T₉ was calculated according to the Fox equation.

### 1. Synthesis Method for Copolymers According to the Invention

### 1.1 Preparation of Copolymer 1.1 According to the Invention

The following mixtures were used as feed 1 to feed 4:

| | | | |
|---|---|---|---|
| Feed 1: | 31 | g | of acrylic acid |
| | 60 | g | of water |
| Feed 2: | 294 | g | of 2-ethylhexyl acrylate |
| | 30 | g | of acrylic acid |
| | 190 | g | of water |
| | 15 | g | of 15% by weight aqueous solution of sodium |
| | | | laurylsulfate |
| | 33 | g | of 31% by weight aqueous solution of |
| | | | isononylphenol polyethoxysulfate (average |
| | | | degree of ethoxylation: 25) |
| | 10 | g | of n-dodecyl mercaptan |
| Feed 3: | 147 | g | of 2-ethylhexyl acrylate |
| | 70 | g | of water |
| | 8.1 | g | of 15% by weight aqueous solution of sodium |
| | | | laurylsulfate |
| | 16 | g | of 31% by weight aqueous solution of |
| | | | isononylphenol polyethoxysulfate (average |
| | | | degree of ethoxylation: 25) |
| | 5.2 | g | of n-dodecyl mercaptan |
| Feed 4: | 10 | g | of sodium paroxodisulfate |
| | 160 | g | of water |

A mixture of 111 g of water and 10 g of a 15% by weight aqueous solution of sodium laurylsulfate was initially taken in a 2 l polymerization vessel and heated to 80° C. with stirring in the course of 10 minutes. At 80° C., beginning simultaneously, feed 1 was metered in continuously in the course of one hour and feed 4 was metered in continuously in the course of 4.5 hours. After the end of the addition of feed 1, feed 2 was metered continuously into the polymerization vessel at 80° C. in the course of 2 hours. After the end of the addition of feed 2, feed 3 was metered continuously into the polymerization vessel at 80° C. in the course of one hour. The resulting reaction mixture was then stirred for a further 90 minutes at 80° C. Thereafter, cooling to room temperature was effected and a solution of 16.5 g of NaOH in 80 g of water was added to the resulting reaction mixture. The resulting reaction mixture was stirred for 30 minutes at room temperature. Copolymer CP1.1 according to the invention was obtained as an aqueous dispersion. The aqueous dispersion of CP1.1 thus prepared had a solids content of 42.9% and a pH of 5.0.

Stage A: T_{g}=130° C., stage B: T_{g}=−48° C., stage C: T_{g}=−58° C.
Serum: M_{w}=87 000 g/mol

### 1.2 Preparation of Copolymer 1.2 According to the Invention

The following mixtures were prepared as feed 1 and feed 2:

| | | | |
|---|---|---|---|
| Feed 1: | 441 | g | of ethylhexyl acrylate |
| | 9.3 | g | of acrylic acid |
| | 220 | g | of water |
| | 23 | g | of 15% by weight aqueous solution of sodium |
| | | | laurylsulfate |
| | 49 | g | of 31% by weight aqueous solution of |
| | | | isononylphenol polyethoxysulfate (average |
| | | | degree of ethoxylation: 25) |
| | 12 | g | of n-dodecyl mercaptan |
| Feed 2: | 7.8 | g | of sodium peroxodisulfate |
| | 124 | g | of water |

A mixture of 200 g of water, 10 g of a 15% by weight aqueous solution of sodium laurylsulfate and 52 g of a high molecular weight polyacrylic acid (M_{w}=310 000 g/mol) was initially taken in a 2 l polymerization vessel and heated to 80° C. with stirring in the course of 10 minutes. At 80° C., beginning simultaneously, feed 1 was metered in continuously in the course of 3 hours and feed 2 was metered in continuously in the course of 3.5 hours. The resulting reaction mixture was then stirred for a further 90 minutes at 80° C. Thereafter, cooling to room temperature was effected and a solution of 16.5 g of NaOH in 80 g of water was added to the resulting reaction mixture. The resulting reaction mixture was stirred for 30 minutes at room temperature. Copolymer CP1.2 according to the invention was obtained as an aqueous dispersion. The aqueous dispersion of CP1.2 thus prepared had a solids content of 43.8% and a pH of 5.3.

Stage A: T_{g}=130° C., stage B: T_{g}=−56° C.
Serum: M_{w}=310 000 g/mol

### 1.3. Preparation of Copolymer 1.3 According to the Invention

The following mixtures were prepared as feed 1 to feed 4:

| | | | |
|---|---|---|---|
| Feed 1: | 36 | g | of methacrylic acid |
| | 140 | g | of water |
| Feed 2: | 287 | g | of 2-ethylhexyl acrylate |
| | 35 | g | of methacrylic acid |
| | 130 | g | of water |
| | 15 | g | of 15% by weight aqueous solution of sodium |
| | | | laurylsulfate |
| | 33 | g | of 31% by weight aqueous solution of |
| | | | isononylphenol polyethoxysulfate (average |
| | | | degree of ethoxylation: 25) |
| | 10 | g | of n-dodecyl mercaptan |
| Feed 3: | 143 | g | of 2-ethylhexyl acrylate |
| | 65 | g | of water |
| | 8.1 | g | of 15% by weight aqueous solution of sodium |
| | | | laurylsulfate |
| | 16 | g | of 31% by weight aqueous solution of |
| | | | isononylphenol polyethoxysulfate (average |
| | | | degree of ethoxylation: 25) |
| | 5.2 | g | of n-dodecyl mercaptan |
| Feed 4: | 10 | g | of sodium peroxodisulfate |
| | 160 | g | of water |

A mixture of 130 g of water and 10 g of a 15% by weight aqueous solution of sodium laurylsulfate was initially taken in a 2 l polymerization vessel and heated to 80° C. with stirring in the course of 10 minutes. At 80° C., beginning simultaneously, feed 1 was metered in continuously in the course of one hour and feed 4 was metered in continuously in the course of 4.5 hours. After the end of the addition of feed 1, feed 2 was metered continuously into the polymerization vessel at 80° C. in the course of 2 hours. After the end of the addition of feed 2, feed 3 was metered continuously into the polymerization vessel at 80° C. in the course of one hour. The resulting reaction mixture was then stirred for a further 90 minutes at 80° C. Thereafter, cooling to room temperature was effected and a solution of 16.4 g of NaOH in 62 g of water was added to the resulting reaction mixture. The resulting reaction mixture was stirred for 30 minutes at room temperature. Copolymer CP1.3 according to the invention was obtained as an aqueous dispersion. The aqueous dispersion of CP1.3 thus prepared had a solids content of 41.6% and a pH of 6.1.

Stage A: T_{g}=162° C. stage B: T_{g}=−45° C. stage C: T_{g}=−58° C.
Serum: M_{w}=73 000 g/mol

### 2. Preparation of the Formulations According to the Invention

### 2.1 Preparation of Formulation 2.1 According to the Invention

| | | |
|---|---|---|
| Initially | 650 g | of aqueous dispersion of copolymer CP1.1 (42.9% by |
| taken: | | weight) |
| Feed 1: | 370 g | of aqueous dispersion of maleic anhydride/C₂₀₋₂₄-olefin |
| | | copolymer (25% by weight) |
| Feed 2: | 40 g | of N-oleylsarcosine |
| Feed 3: | 20 g | of C₁₃-oxo alcohol ethoxylate (7 ethylene oxide/mol) |

650 g of an aqueous dispersion of copolymer CP1.1 were initially taken in a 2 l polymerization vessel, and feeds 1 to 3 were added at room temperature in the course of 1 hour. The reaction mixture was then stirred for 1 hour at room temperature. The aqueous formulation 2.1 thus prepared had a solids content of 40.0% by weight and a pH of 5.2.

### 2.2 Preparation of Formulation 2.2 According to the Invention

| | | |
|---|---|---|
| Initially | 650 g | of aqueous dispersion of copolymer CP1.1 (42.9% |
| taken: | | by weight) |
| Feed 1: | 80 g | of N-oleylsarcosine |
| Feed 2: | 40 g | of C₁₃-oxo alcohol ethoxylate (7 ethylene oxide/mol) |

650 g of an aqueous dispersion of copolymer CP1.1 were initially taken in a 2 l polymerization vessel, and feeds 1 and 2 were added at room temperature in the course of 1 hour. The reaction mixture was then stirred for 1 hour at room temperature. The aqueous formulation 2.2 thus prepared had a solids content of 52.0% and a pH of 4.7.

### 3. Testing of Performance Characteristics

The data in % by weight are based in each case on the shaved weight, unless stated otherwise.

### 3.1 Use in the Retanning of Leather—Production of Upper Leather

Two commercial cattle wet blues were shaved to a thickness of from 1.2 to 1.4 mm and cut into halves. The halves were then introduced into a drum (50 l), and 2% by weight of sodium formate and 1.0% by weight of a naphthalenesulfonic acid/formaldehyde condensate, prepared according to U.S. Pat. No. 5,185,846, example “Dispersant 1”, were added at 40° C., the liquor length being 100% by weight. After 60 minutes, the liquor was discharged.

Together with 100% by weight of water, 1% by weight each of a 50% by weight (solids content) aqueous solution of dyes whose solids had the following composition were metered at from 25 to 35° C.:

70 parts by weight of dye from EP-B 0 970 148, example 2.18,
30 parts by weight of Acid Brown 75 (iron complex), Colour Index 1.7.16,
and drumming was effected for 10 minutes in the drum.

6% by weight each of formulations 2.1 and 2.2 according to the invention were then added and drumming was effected for 30 minutes. Thereafter, 8% by weight each of sulfone tanning agent from EP-B 0 459 168, example K1 were added and drumming was effected for a further 30 minutes at 15 revolutions per minute in the drum. Thereafter, the strips were treated for 45 minutes with 3% by weight each of vegetable tanning agent Mimosa® and 1.5% each of the above-defined solution of dyes.

Acidification was then effected with formic acid to a pH of 3.6-3.8. After 20 minutes, the liquors were discharged. Washing was then effected with 200% by weight of water. Finally, 2% by weight of a fatliquoring agent which was prepared as described under 4., were metered into 100% by weight of water at 50° C. After a drumming time of 45 minutes, acidification was effected with 1,% by weight of formic acid.

The washed leathers were dried and staked and were milled for 15 hours.

The leathers 3.1 and 3.2 according to the invention were obtained.

The leathers 3.1 and 3.2 according to the invention had excellent fullness and softness and hand in combination with dyeing of the fibers with excellent penetration. In addition, the leathers exhibited pronounced water repellency without them having been treated with water repellents based on silicone compounds, it being possible for the water repellency according to the invention even to surpass the effect of silicone oils.

### COMPARATIVE EXAMPLE C1

For comparative example C1, the procedure was as above but formulation according to the invention was omitted. The further steps were carried out as above. The comparative leather obtained was substantially harder, less full and substantially more loose-grained compared with the examples with the formulations according to the invention. In addition, the hand was substantially rougher and less soft and velvety.

### 4. Preparation of a Fatliquoring Agent

The following were mixed in a 2 l kettle:

230 g of a polyisobutene having Mₙ=1000 g/mol and M_{w}=1800 g/mol,
30 g of n-C₁₈H₃₇O—(CH₂CH₂O)₂₅—OH
5 g of n-C₁₈H₃₇O—(CH₂CH₂O)₈₀—OH
40 g of oleic acid
230 g of sulfited oxidized triolein

The mixture was heated to 60° C. with stirring, and 470 g of water and 10 g of n-C₁₆H₃₃O—(CH₂CH₂O)₇—OH were added. The resulting emulsion was then passed through a gap homogenizer. A finely divided, stable emulsion was obtained.

1. A process for the production of leather comprising treating leather with at least one copolymer, wherein, in one stage
(A) at least one (co)polymer is prepared from a monomer or a mixture of comonomers comprising
(a1) from 80 to 100% by weight of at least one ethylenically unsaturated carboxylic acid,
(a2) from 0 to 20% by weight of at least one C₁-C₂₂-alkyl ester of at least one ethylenically unsaturated carboxylic acid,
(a3) from 0 to 10% by weight of at least one further ethylenically unsaturated compound,
data in % by weight being based on the total amount of comonomers of the relevant stage,
and the (co)polymer thus obtained is reacted in a subsequent stage
(B) with a further comonomer or a further mixture of comonomers comprising
(b1) from 0 to 30% by weight of at least one ethylenically unsaturated carboxylic acid,
(b2) from 70 to 100% by weight of at least one C₁-C₂₂-alkyl ester of at least one ethylenically unsaturated carboxylic acid,
(b3) from 0 to 10% by weight of at least one further ethylenically unsaturated compound,
data in % by weight being based on the total amount of comonomers of the relevant further stage.

2. The process according to claim 1, wherein, in the preparation of the copolymer, in at least one further stage (C), reaction is effected with at least one further monomer selected from
(c1) at least one C₁-C₂₂-alkyl ester of at least one ethylenically unsaturated carboxylic acid.

3. The process according to claim 1, wherein the difference between the glass transition temperatures T_{g} of polymer or of random copolymer from stage (A) and polymer or random copolymer from stage (B) is at least 80° C.

4. The process according to claim 1, wherein at least one copolymer used has a molecular weight M_{w} in the range from 30 000 to 750 000 g/mol.

5. The process according to claim 1, wherein at least one copolymer used is partly or completely neutralized with a basic alkali metal compound or basic anine.

6. A method for the production of leather comprising treating the leather with copolymers prepared by copolymerization in at least two stages, wherein, in one stage
(A) at least one (co)polymer is prepared from a monomer or a mixture of comonomers comprising
(a1) from 80 to 100° by weight of at least one ethylenically unsaturated carboxylic acid,
(a2) from 0 to 20% by weight of at least one C₁-C₂₂-alkyl ester of at least one ethylenically unsaturated carboxylic acid,
(a3) from 0 to 10% by weight of at least one further ethylenically unsaturated compound,
data in % by weight being based on the total amount of comonomers of the relevant stage,
and the (co)polymer thus obtained is reacted in a subsequent stage
(B) with a further comonomer or a further mixture of comonomers comprising
(b1) from 0 to 30% by weight of at least one ethylenically unsaturated carboxylic acid,
(b2) from 70 to 100% by weight of at least one C₁-C₂₂-alkyl ester of at least one ethylenically unsaturated carboxylic acid,
(b3) from 0 to 10% by weight of at least one further ethylenically unsaturated compound,
data in % by weight being based on the total amount of comonomers of the relevant further stage.

7. A formulation comprising at least one copolymer prepared by copolymerization in at least two stages, wherein, in one stage
(A) at least one (co)polymer is prepared from a monomer or a mixture of comonomers comprising
(a1) from 80 to 100% by weight of at least one ethylenically unsaturated carboxylic acid,
(a2) from 0 to 20% by weight of at least one C₁-C₂₂-alkyl ester of at least one ethylenically unsaturated carboxylic acid,
(a3) from 0 to 10% by weight of at least one further ethylenically unsaturated compound,
data in % by weight being based on the total amount of comonomers of the relevant stage,
and the (co)polymer thus obtained is reacted in a subsequent stage
(B) with a further comonomer or a further mixture of comonomers comprising
(b1) from 0 to 30% by weight of at least one ethylenically unsaturated carboxylic acid.
(b2) from 70 to 100% by weight of at least one C₁-C₂₂-alkyl ester of at least one ethylenically unsaturated carboxylic acid,
(b3) from 0 to 10% by weight of at least one further ethylenically unsaturated compound,
data in % by weight being based on the total amount of comonomers of the relevant further stage and also at least one hydrophobic or amphiphilic substance selected from oils, waxes and synthetic poly ers.

8. The formulation according to claim 7, wherein, in the preparation of the copolymer, in at least one further stage (C), reaction is effected with at least one further monomer selected from
(c1) at least one C₁-C₂₂-alkyl ester of at least one ethylenically unsaturated carboxylic acid.

9. The formulation according to claim 7, wherein the difference between the glass transition temperatures T_{g} of polymer or of random copolymer from stage (A) and polymer or random copolymer from stage (B) is at least 80° C.

10. The formulation according to claim 7, wherein at least one copolymer has a molecular weight M_{w} in the range from 30 000 to 750 000 g/mol.

11. The formulation according to claim 7, wherein at least one copolymer is partly or completely neutralized with a basic alkali metal compound or basic amine.

12. The formulation according to claim 7, comprising at least one emulsifier.

13. The leather produced according to the process of claim 1.

14. An automotive part comprising at least one leather according to claim 13.

15. A leather treated with at least one formulation according to claim 7.

16. An automotive part comprising at least one leather according to claim 15.
